(19) United States
(12) Patent Application Publication
(10) Pub. No.: US 2016/0191898 A1
(43) Pub. Date: Jun. 30, 2016

(54) Image Processing Method and Electronic Device

(71) Applicant: Lenovo (Beijing) Co., Ltd., Beijing (CN)

(72) Inventors: Li Xu, Beijing (CN); Qiong Yan, Beijing (CN)

(73) Assignee: LENOVO (BEIJING) CO., LTD., Beijing (CN)

(21) Appl. No.: 14/667,976

(22) Filed: Mar. 25, 2015

(30) Foreign Application Priority Data
Dec. 31, 2014 (CN) 201410854068.6

(51) Int. Cl. H04N 13/02

(52) U.S. Cl. CPC H04N 13/0239; H04N 13/0271; H04N 2213/003

(57) ABSTRACT

An image processing method is applied to an electronic device having a binocular camera that includes a first camera and a second camera. The method includes acquiring at least one first image taken by the first camera of the binocular camera and at least one second image taken by the second camera of the binocular camera; acquiring depth images in scenes of the at least one first image and the at least one second image; differentiating, based on the depth images, foregrounds and backgrounds in the scenes of the at least one first image and the at least one second image; and matching and stitching the foregrounds of the at least one first image and the at least one second image, and matching and stitching the backgrounds of the at least one first image and the at least one second image, so as to obtain a stitched third image.

This application claims priority to Chinese patent application No. 201410854068.6 filed on Dec. 31, 2014, the entire contents of which are incorporated herein by reference.

The present application relates to image processing technology, and more particularly, to an image processing method and an electronic device.

### BACKGROUND

In recent years, electronic devices with an image capturing function have become increasingly popular. Typically, handheld electronic devices usually have a front camera by which users can take a self-picture. However, the front camera for taking a self-picture in the handheld electronic devices usually can only take a bust shot of the users, it is difficult for the users to take a full-length shot by using the front camera, and the users cannot use the front camera to take a picture of multiple persons.

One solution is that the users can use a long rod to place the handheld electronic devices at a distance farther away from themselves, so as to take a full-length shot or take a picture of multiple persons. However, the problem with this solution is that the users must carry a long rod to take a self-picture or a picture of multiple persons, it is quite inconvenient for the users to carry a long rod, which affects using experience of the users, and is hard to be widely used by the users.

Therefore, the urgent problem that needs to be solved is how to optimize the front image capturing method and apparatus in the conventional electronic devices so that the users can use the front image capturing method and apparatus in the electronic devices to take a full-length self-picture or take a picture of multiple persons, thereby the front image capturing method and apparatus applied to the electronic devices become more practical, and using experience of the users is improved.

### SUMMARY

According to an aspect of the present application, there is provided an image processing method applied to an electronic device having a binocular camera that includes a first camera and a second camera, the method comprising: acquiring at least one first image taken by the first camera of the binocular camera and at least one second image taken by the second camera of the binocular camera; acquiring depth images in scenes of the at least one first image and the at least one second image; differentiating, based on the depth images, foregrounds and backgrounds in the scenes of the at least one first image and the at least one second image; and matching and stitching the foregrounds of the at least one first image and the at least one second image, and matching and stitching the backgrounds of the at least one first image and the at least one second image, so as to obtain a stitched third image.

Further, according to an embodiment of the present application, the method further comprises: obtaining a foreground mask and a background mask in the at least one first image and the at least one second image, after acquiring depth images in scenes of the at least one first image and the at least one second image.

Further, according to an embodiment of the present application, the method further comprises: processing the foregrounds and backgrounds of the at least one first image and the at least one second image to obtain a first feature corresponding point transform matrix of the foregrounds of the at least one first image and the at least one second image, and a second feature corresponding point transform matrix of the backgrounds of the at least one first image and the at least one second image; optimizing the foreground mask and the background mask based on the first feature corresponding point transform matrix and the second feature corresponding point transform matrix; and matching and stitching the foregrounds of the at least one first image and the at least one second image based on the optimized foreground mask, and matching and stitching the backgrounds of the at least one first image and the at least one second image based on the optimized background mask.

Further, according to an embodiment of the present application, differentiating the foregrounds and backgrounds based on the depth images comprises: differentiating the foregrounds and backgrounds by using a clustering scheme based on depth information in relation to the depth images.

Further, according to an embodiment of the present application, optimizing the foreground mask and the background mask comprises: using a standard graph-cut scheme based on the first feature corresponding point transform matrix and the second feature corresponding point transform matrix to optimize the foreground mask and the background mask.

Further, according to an embodiment of the present application, matching and stitching the foregrounds of the at least one first image and the at least one second image based on the optimized foreground mask, and matching and stitching the backgrounds of the at least one first image and the at least one second image based on the optimized background mask comprises: selecting a median of component values of pixels in the at least one first image and the at least one second image as a component value of corresponding pixels in the stitched third image by using a median fusion scheme.

According to another aspect of the present application, there is provided an electronic device, comprising: a binocular camera, which includes a first camera and a second camera; a shooting unit configured to acquire at least one first image taken by the first camera of the binocular camera and at least one second image taken by the second camera of the binocular camera; a depth image acquiring unit configured to acquire depth images in scenes of the at least one first image and the at least one second image; a foreground-background differentiating unit configured to differentiate, based on the depth images, foregrounds and backgrounds in the scenes of the at least one first image and the at least one second image; and an image synthesis unit configured to match and stitch the foregrounds of the at least one first image and the at least one second image, and match and stitch the backgrounds of the at least one first image and the at least one second image.

Further, according to an embodiment of the present application, the foreground-background differentiating unit is further configured to obtain a foreground mask and a background mask in the at least one first image and the at least one second image.

Further, according to an embodiments of the present application, the electronic device further comprises: a feature point processing unit configured to process the foregrounds and backgrounds of the at least one first image and the at least one second image to obtain a first feature corresponding point transform matrix of the foregrounds of the at least one first image and obtain the at least one second image, and a second feature corresponding point transform matrix of the backgrounds of the at least one first image and the at least one second image; a mask optimizing unit configured to optimize the foreground mask and the background mask based on the first feature corresponding point transform matrix and the second feature corresponding point transform matrix; and the image synthesis unit is further configured to match and stitch the foregrounds of the at least one first image and the at least one second image based on the optimized foreground mask, and match and stitch the backgrounds of the at least one first image and the at least one second image based on the optimized background mask.

Further, according to an embodiment of the present application, the foreground-background differentiating unit is further configured to differentiate the foregrounds and backgrounds by using a clustering scheme based on depth information in relation to the depth images.

Further, according to an embodiment of the present application, the mask optimizing unit is further configured to optimize the foreground mask and the background mask by using a standard graph-cut scheme based on the first feature corresponding point transform matrix and the second feature corresponding point transform matrix.

Further, according to an embodiment of the present application, the image synthesis unit is further configured to select a median of component values of pixels in the at least one first image and the at least one second image as a component value of corresponding pixels in the stitched third image by using a median fusion scheme.

### BRIEF DESCRIPTION OF THE DRAWINGS

FIG. 1 is a schematic structural block diagram of the electronic device 100 according to an embodiment of present application;

FIG. 2 is a flowchart of the image capturing method 200 applied to the electronic device 100 according to an embodiment of the present application;

FIG. 3 is a schematic structural block diagram of the image capturing apparatus 300 applied to the electronic device 100 according to an embodiment of the present application;

FIG. 4A is a schematic diagram illustrating a shot scene of an example according to an embodiment of the present application;

FIG. 4B is a schematic diagram illustrating the foreground and background of a shot scene of an example according to an embodiment of the present application after being clustered;

FIG. 5 is a schematic diagram illustrating correspondence between corresponding feature points in two adjacent images according to an embodiment of the present application;

FIG. 6A is a schematic diagram illustrating the foreground mask and background mask before being optimized according to an embodiment of the present application; and

FIG. 6B is a schematic diagram illustrating the foreground mask and background mask after being optimized according to an embodiment of the present application.

### DETAILED DESCRIPTION

Hereinafter, preferred embodiments of the present application will be described in detail with reference to the attached drawings. It should be noted that procedures and elements that are substantially the same are denoted by the same reference signs in this specification and the attached drawings, and repeated explanations of these steps and elements will be omitted.

The “one embodiment” or “an embodiment” mentioned throughout this specification means that particular features, structures, or characteristics described in conjunction with the embodiment are included in at least one embodiment described therein. Therefore, emergence of the phrase “in one embodiment” or “in an embodiment” in this specification not necessarily denotes only a single embodiment. In addition, said particular features, structures, or characteristics may be combined in one or more embodiments in any suitable manner.

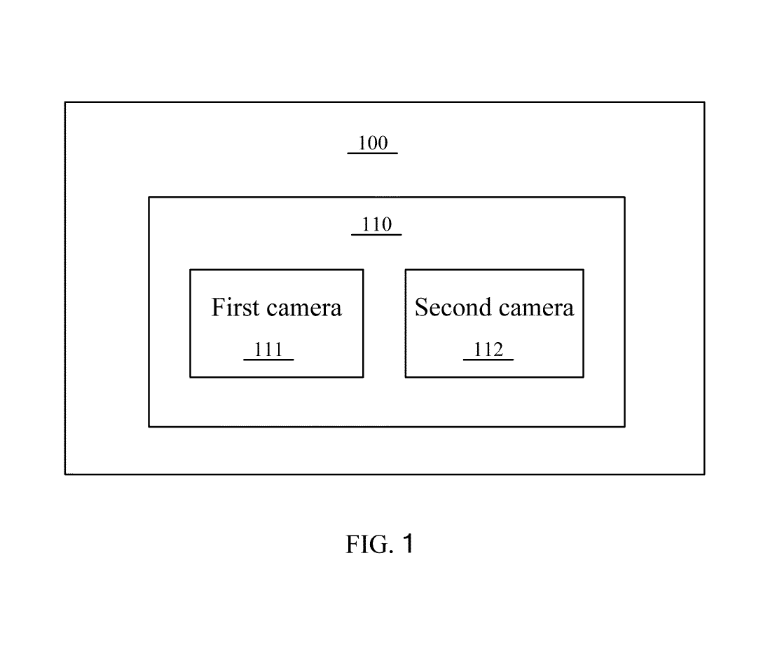

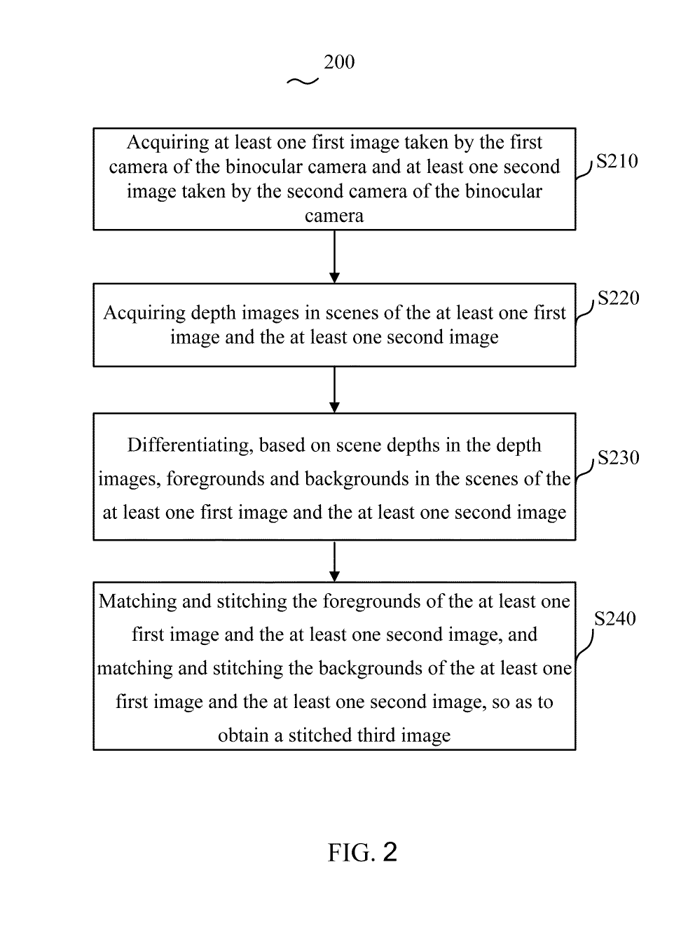

FIG. 2 is a flowchart of the image capturing method 200 applied to the electronic device 100 according to an embodiment of the present application, wherein as shown in FIG. 1, the electronic device 100 may include a binocular camera 110, the binocular camera 110 may include a first camera 111 and a second camera 112.

Next, the image capturing method 200 applied to the electronic device 100 according to an embodiment of the present application will be described with reference to FIG. 2. As shown in FIG. 2, first, in step S210, at least one first image taken by the first camera 111 of the binocular camera 110 and at least one second image taken by the second camera 112 of the binocular camera 110 are acquired. In particular, in an embodiment of the present application, the users can acquire at least one first image taken by the first camera 111 of the binocular camera 110 and at least one second image taken by the second camera 112 of the binocular camera 110 while controlling the electronic device 100 to move, controlling the electronic device 100 to move may include: controlling the electronic device 100 to move horizontally or controlling the electronic device 100 to move vertically.

Then, in step S220, depth images in scenes of the at least one first image and the at least one second image may be acquired. In particular, in an embodiment of the present application, depth images of the shot scenes may be obtained by using a position difference of pixels with the same image content in a left image and a right image taken simultaneously by using two cameras of a left camera and a right camera. For instance, based on the left image 1 and the right image r taken simultaneously by the two cameras of the left camera and the right camera, position points xₗ and xᵣ of pixels with the same image content may be found, respectively, a formula of a depth Z of a certain point P in the shot scene may be obtained according to position relationship between similar triangles:

$$Z = f * \frac{T}{{X}_{l} - {X}_{r}} ,$$

where f is a focal length between the left camera and the right camera, T is a baseline length of the left camera and the right camera, thus it is obtained that the depth of the shot scene is related to a distance between the position points xₗ and xᵣ of pixels with the same image content in the two images of the left image and the right image that are taken simultaneously:

$$d = {x}_{l} - {x}_{r} ∝ \frac{1}{Z}$$

Thereby, the scene depth relationship may be obtained based on the parallax d.

Therefore, in step S230, foregrounds and backgrounds in the scenes of the at least one first image and the at least one second image may be differentiated based on the depth images. In particular, in an embodiment of the present application, scenes in the depth images may be differentiated into foregrounds and backgrounds based on depth information by using a clustering scheme. In addition, according to an embodiment of the present application, after acquiring depth images in scenes of the at least one first image and the at least one second image, a foreground mask and a background mask in the at least one first image and the at least one second image may be obtained. For instance, after acquiring the depth map of the shot scene in step S220, the depths of the foreground and the background of the scene captured by the front camera usually have a big difference, thus clustering may be performed based on the obtained depth map and color, so that specific foreground mask and background mask are differentiated. Typically, a K-means clustering scheme may be used to classify the scene images into two categories: foreground category and background category. The K-means clustering scheme is well known by those skilled in the art, no more details repeated herein. As shown in FIGS. 4A to 4B, FIG. 4A is a schematic diagram illustrating a shot scene of an example according to an embodiment of the present application; FIG. 4B is a schematic diagram illustrating the foreground of a shot scene of an example according to an embodiment of the present application after being clustered. In FIG. 4B, the white is the foreground, the black is the background. Typically, the differentiating result of such clustering is rough, edges of the foreground are not accurate, thus in a subsequent step, it is impossible to obtain a stitching parameter between different frames, since typically the parameter for the foreground and the parameter for the background may be totally different, so it is possible to process the foregrounds and the backgrounds, respectively, and then stitch a plurality of images.

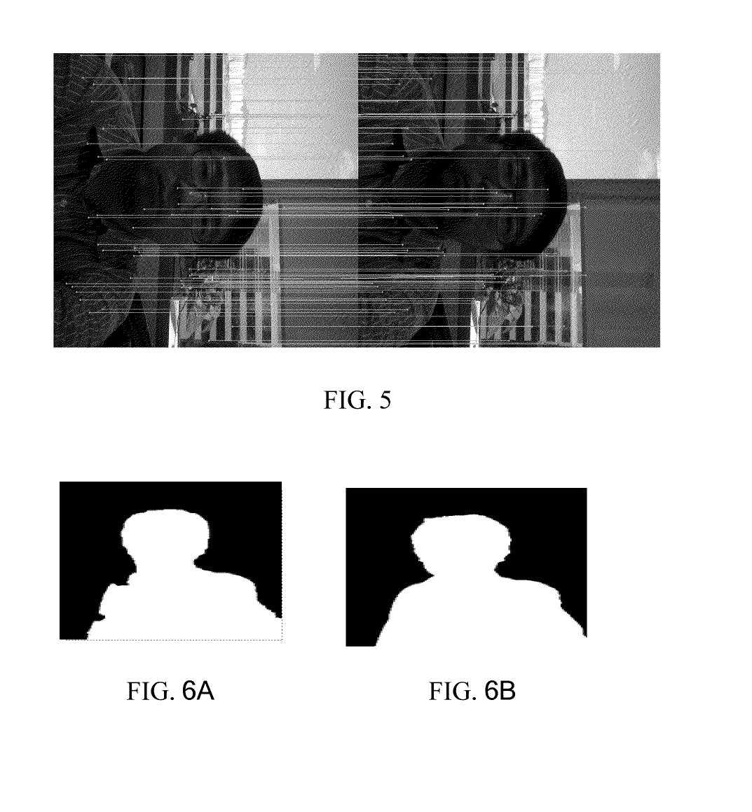

In particular, in an embodiment of the present application, the foregrounds and backgrounds of the at least one first image and the at least one second image may be processed to obtain a first feature corresponding point transform matrix of the foregrounds of the at least one first image and the at least one second image, and a second feature corresponding point transform matrix of the backgrounds of the at least one first image and the at least one second image, respectively. For instance, in one example, corresponding feature points in two adjacent images may be first obtained, for instance, corresponding feature points in two adjacent first images or two adjacent second images may be obtained. Usually, the above feature points include foreground feature points and background feature points, for instance, FIG. 5 is a schematic diagram illustrating correspondence between corresponding feature points in two adjacent images according to an embodiment of the present application. Usually, the foreground is processed first, corresponding feature points in the foreground mask may be obtained with the previously obtained foreground mask, the feature corresponding point transform matrix H_{f} may be obtained with a plurality of feature corresponding points, the feature corresponding point transform matrix H_{f} may also be optimized, the methods to obtain and optimize the feature corresponding point transform matrix H_{f} are well known for those skilled in the art, no more details repeated. Likewise, it is possible to obtain a transform matrix H_{b} with respect to background feature corresponding point. Thereby, if the first image that is taken at the earliest is taken as a reference image, then the foreground and background transform matrix from each image in the shooting sequence to the reference image may be obtained in order.

According to an embodiment of the present application, after obtaining the foreground and background transform matrix from each image in the shooting sequence to the reference image, it is possible to optimize the foreground mask and the background mask by using the first feature corresponding point transform matrix and the second feature corresponding point transform matrix. In particular, it is possible to optimize the foreground mask and the background mask by using the first feature corresponding point transform matrix, the second feature corresponding point transform matrix, and a standard graph-cut scheme. For instance, FIGS. 6A and 6B are schematic diagrams illustrating the foreground mask and background mask before and after being optimized according to an embodiment of the present application, in this step, inaccurate points in the previous foreground mask may be restored, in particular, it is possible to use the obtained feature point transform matrix of respective images to correspond the respective images to the reference image, as for the foreground, points with a less error may be selected as the very determined foreground points, likewise, as for the background, points with a less error may be selected as the very determined background points. Then, with the already known foreground image point and background image point and image color, the optimized masks may be obtained by adopting the standard graph-cut algorithm well known for those skilled in the art.

Next, in step 240, the foregrounds of the at least one first image and the at least one second image are matched and stitched, and the backgrounds of the at least one first image and the at least one second image are matched and stitched, so as to obtain a stitched third image. In particular, the foregrounds of the at least one first image and the at least one second image may be matched and stitched based on the optimized foreground mask, and the backgrounds of the at least one first image and the at least one second image may be matched and stitched based on the optimized background mask. In an embodiment of the present application, it is possible to select a median of component values of pixels in the at least one first image and the at least one second image as a relative component value of relative pixels in the stitched third image by using a median fusion scheme. For instance, the foreground mask and the background mask of each image is corresponded to the reference image, respectively, a median fusion is applied to the at least one first image and the at least one second image, that is, selecting a median in candidate pixels for any pixel in the image as the last result, so as to obtain the stitched image.

Accordingly, the image capturing method 200 provided by the present application can optimize the front image capturing function of conventional electronic devices, so that the users can use the front image capturing method and apparatus in the electronic devices to take a full-length self-picture or take a picture of multiple persons, thereby the front image capturing method and apparatus applied to the electronic devices become more practical, and using experience of the users is improved.

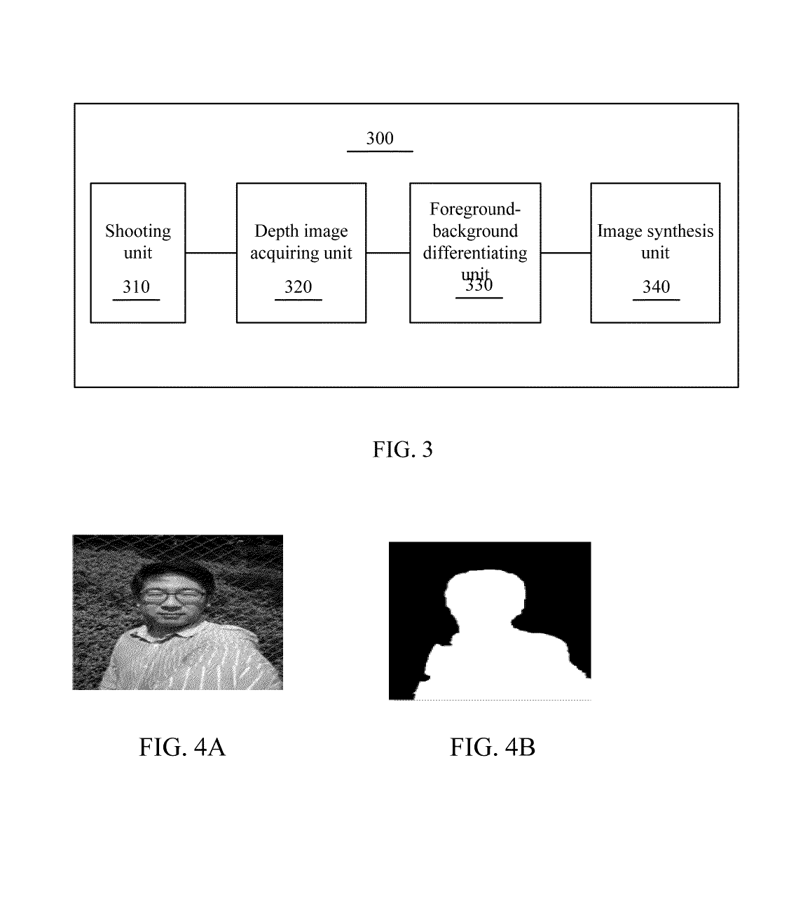

FIG. 3 is a schematic structural block diagram of the image capturing apparatus 300 applied to the electronic device 100 according to an embodiment of the present application, as shown in FIG. 1, the electronic device 100 may include a binocular camera 110, the binocular camera 110 may include a first camera 111 and a second camera 112. The image apparatus 300 applied to the electronic device 100 according to an embodiment of the present application will be described below with reference to FIG. 3. As shown in FIG. 3, the image capturing apparatus 300 comprises: a shooting unit 310, a depth image acquiring unit 320, a foreground-background differentiating unit 330, and an image synthesis unit 340.

In particular, the shooting unit 310 is configured to acquire at least one first image taken by the first camera 111 of the binocular camera 110 and at least one second image taken by the second camera 112 of the binocular camera 110. Specifically, in an embodiment of the present application, the shooting unit 310 may acquire at least one first image taken by the first camera 111 of the binocular camera 110 and at least one second image taken by the second camera 112 of the binocular camera 110 while the user controls the electronic device 100 to move, the user controls the electronic device 100 to move may include: controlling the electronic device 100 to move horizontally or controlling the electronic device 100 to move vertically.

The depth image acquiring unit 320 is configured to acquire depth images in scenes of the at least one first image and the at least one second image. In particular, in an embodiment of the present application, the depth image acquiring unit 320 may obtain depth images of the shot scenes by using a position difference of pixels with the same image content in a left image and a right image taken simultaneously by using two cameras of a left camera and a right camera. For instance, based on the left image 1 and the right image r taken simultaneously by the two cameras of the left camera and the right camera, the depth image acquiring unit 320 may find position points xₗ and xᵣ of pixels with the same image content, respectively, obtain a formula of a depth Z of a certain point P in the shot scene according to position relationship between similar triangles:

$$Z = f * \frac{T}{{X}_{l} - {X}_{r}} ,$$

where f is a focal length between the left camera and the right camera, T is a baseline length of the left camera and the right camera, thus it is obtained that the depth of the shot scene is related to a distance between the position points xₗ and xᵣ of pixels with the same image content in the two images of the left image and the right image that are taken simultaneously:

$$d = {x}_{l} - {x}_{r} ∝ \frac{1}{Z}$$

Thereby, the scene depth relationship may be obtained based on the parallax d.

The foreground-background differentiating unit 330 is configured to differentiate, based on the depth images, foregrounds and backgrounds in the scenes of the at least one first image and the at least one second image. In particular, in an embodiment of the present application, the foreground-background differentiating unit 330 may differentiate scenes in the depth images into foregrounds and backgrounds based on depth information by using a clustering scheme. In addition, according to an embodiment of the present application, after the depth image acquiring unit 320 acquires depth images in scenes of the at least one first image and the at least one second image, a foreground mask and a background mask in the at least one first image and the at least one second image may be obtained. For instance, after the depth image acquiring unit 320 acquires the depth map of the shot scene, the depths of the foreground and the background of the scene captured by the front camera usually have a big difference, thus the foreground-background differentiating unit 330 may perform clustering based on the obtained depth map and color, so that specific foreground mask and background mask are differentiated. Typically, a K-means clustering scheme may be used to classify the scene images into two categories: foreground category and background category. The K-means clustering scheme is well known by those skilled in the art, no more details repeated herein. As shown in FIGS. 4A to 4B, FIG. 4A is a schematic diagram illustrating a shot scene of an example according to an embodiment of the present application; FIG. 4B is a schematic diagram illustrating the foreground and background of a shot scene of an example according to an embodiment of the present application after being clustered. In FIG. 4B, the white is the foreground, the black is the background. Typically, the differentiating result of such clustering is rough, edges of the foreground are not accurate, thus the image capturing apparatus 300 may obtain a stitching parameter between different frames, since typically the parameter for the foreground and the parameter for the background may be totally different, so the image capturing apparatus may process the foregrounds and the backgrounds, respectively, and then stitch a plurality of images.

In particular, in an embodiment of the present application, the image capturing apparatus further comprises: a feature point processing unit configured to process the foregrounds and backgrounds of the at least one first image and the at least one second image to obtain a first feature corresponding point transform matrix of the foregrounds of the at least one first image and the at least one second image, and a second feature corresponding point transform matrix of the backgrounds of the at least one first image and the at least one second image, respectively. For instance, in one example, the feature point processing unit may first obtain corresponding feature points in two adjacent images (the first image and the second image). Usually, the above feature points include foreground feature points and background feature points, for instance, FIG. 5 is a schematic diagram illustrating correspondence between corresponding feature points in two adjacent images according to an embodiment of the present application. Usually, the feature point processing unit may first process the foreground, obtain corresponding feature points in the foreground mask with the previously obtained foreground mask, obtain the feature corresponding point transform matrix H_{f} with a plurality of feature corresponding points, and also optimize the feature corresponding point transform matrix H_{f}, the methods to obtain and optimize the feature corresponding point transform matrix H_{f} are well known for those skilled in the art, no more details repeated. Likewise, the feature point processing unit may obtain a transform matrix H_{b} with respect to background feature corresponding point. Thereby, if the first image that is taken at the earliest is taken as a reference image, then the foreground and background transform matrix from each image in the shooting sequence to the reference image may be obtained in order.

In addition, according to an embodiment of the present application, the image capturing apparatus further comprises: a mask optimizing unit configured to optimize the foreground mask and the background mask based on the first feature corresponding point transform matrix and the second feature corresponding point transform matrix. In particular, the mask optimizing unit may optimize the foreground mask and the background mask by using the first feature corresponding point transform matrix, the second feature corresponding point transform matrix, and a standard graph-cut scheme. For instance, FIGS. 6A and 6B are schematic diagrams illustrating the foreground mask and background mask before and after being optimized according to an embodiment of the present application, in this step, inaccurate points in the previous foreground mask obtained by the foreground-background differentiating unit 330 may be restored, in particular, the mask optimizing unit may use the obtained feature point transform matrix of respective images to correspond the respective images to the reference image, as for the foreground, points with a less error may be selected as the very determined foreground points, likewise, as for the background, points with a less error may be selected as the very determined background points. Then, with the already known foreground image point and background image point and image color, the mask optimizing unit may obtain the optimized masks by adopting the standard graph-cut algorithm well known for those skilled in the art.

An image synthesis unit 340 is configured to match and stitch the foregrounds of the at least one first image and the at least one second image based on an optimized foreground mask, and match and stitch the backgrounds of the at least one first image and the at least one second image, so as to obtain a stitched third image based on an optimized background mask. In particular, the image synthesis unit 340 may match and stitch the foregrounds of the at least one first image and the at least one second image based on the optimized foreground mask, and match and stitch the backgrounds of the at least one first image and the at least one second image based on the optimized background mask. In an embodiment of the present application, the image synthesis unit 340 may select a median of component values of pixels in the at least one first image and the at least one second image as a relative component value of relative pixels in the stitched third image by using a median fusion scheme. For instance, the image synthesis unit 340 may correspond the foreground mask and the background mask of each image to the reference image, respectively, apply a median fusion to the at least one first image and the at least one second image, that is, selecting a median in candidate pixels for any pixel in the image as the last result, so as to obtain the stitched image.

Accordingly, the image capturing apparatus 300 provided by the present application can optimize the front image capturing function of conventional electronic devices, so that the users can use the front image capturing method and apparatus in the electronic devices to take a full-length self-picture or take a picture of multiple persons, thereby the front image capturing method and apparatus applied to the electronic devices become more practical, and using experience of the users is improved.

Finally, it should be noted that, the above-described series of processings do not only comprise processings executed chronologically in the order mentioned here, and also comprise processings executed in parallel or individually but not chronologically.

Through the above description of the implementations, a person skilled in the art can clearly understand that the present disclosure may be implemented in a manner of software plus a necessary hardware platform, and of course the present disclosure may also be implemented fully by hardware. Based on such understanding, the technical solution of the present disclosure that contributes to the background art may be embodied in whole or in part in the form of a software product. The computer software product may be stored in a storage medium, such as ROM/RAM, disk, CD-ROM, and include several instructions for causing a computer apparatus (which may be a personal computer, a server, or a network device) to perform the method described in the various embodiments of the present disclosure or certain parts thereof.

In the embodiments of the present application, units/modules may be implemented by software, so as to be executed by various processors. As an example, an identified module of executable codes may include one or more physical or logical blocks of computer instructions, it may for example be constructed as an object, a process, or a function. Despite of this, executable codes of the identified module do not have to be physically located together, instead they may include instructions stored in different bits, and when these instructions are combined together logically, they constitute the units/modules and implement specified purposes of the units/modules.

When the units/modules may be implemented by software, taking the level of hardware process at present into account, those skilled in the art can build corresponding hardware circuits to implement corresponding functions with respect to the units/modules that can be implemented by software without considering the cost. The hardware circuits include conventional Very Large Scale Integrated (VLSI) circuits or Gate Arrays, and existing semiconductors such as logic chips, transistors and the like or other separated elements. The module may further be implemented by programmable hardware devices, such as Field Programmable Gate Array, Programmable Array Logic, Programmable Logic Device and the like.

Although the present disclosure has been described in detail in the above, specific examples are applied in this text to demonstrate the principles and implementations of the present disclosure, these descriptions of the above embodiments are only to help understand the method of the present disclosure and its core concept. Meanwhile, for a person with ordinary skill in the art, depending on the concepts of the present disclosure, modifications may be made to the specific implementations and applications. To sum up, contents of this specification should not be construed as limiting the present disclosure.

1. An image processing method applied to an electronic device having a binocular camera that includes a first camera and a second camera, the method comprising:
acquiring at least one first image taken by the first camera of the binocular camera and at least one second image taken by the second camera of the binocular camera;
acquiring depth images in scenes of the at least one first image and the at least one second image;
differentiating, based on the depth images, foregrounds and backgrounds in the scenes of the at least one first image and the at least one second image; and
matching and stitching the foregrounds of the at least one first image and the at least one second image, and matching and stitching the backgrounds of the at least one first image and the at least one second image, so as to obtain a stitched third image.

2. The image processing method as claimed in claim 1, further comprising obtaining a foreground mask and a background mask in the at least one first image and the at least one second image after acquiring depth images in scenes of the at least one first image and the at least one second image.

3. The image processing method as claimed in claim 2, further comprising:
processing the foregrounds and backgrounds of the at least one first image and the at least one second image to obtain a first feature corresponding point transform matrix of the foregrounds of the at least one first image and the at least one second image, and a second feature corresponding point transform matrix of the backgrounds of the at least one first image and the at least one second image;
optimizing the foreground mask and the background mask based on the first feature corresponding point transform matrix and the second feature corresponding point transform matrix; and
matching and stitching the foregrounds of the at least one first image and the at least one second image based on the optimized foreground mask, and matching and stitching the backgrounds of the at least one first image and the at least one second image based on the optimized background mask.

4. The image processing method as claimed in claim 1, wherein differentiating the foregrounds and backgrounds based on the depth images comprises differentiating the foregrounds and backgrounds by using a clustering scheme based on depth information in relation to the depth images.

5. The image processing method as claimed in claim 3, wherein optimizing the foreground mask and the background mask comprises using a standard graph-cut scheme based on the first feature corresponding point transform matrix and the second feature corresponding point transform matrix to optimize the foreground mask and the background mask.

6. The image capturing method as claimed in claim 3, wherein matching and stitching the foregrounds of the at least one first image and the at least one second image based on the optimized foreground mask, and matching and stitching the backgrounds of the at least one first image and the at least one second image based on the optimized background mask comprises selecting a median of component values of pixels in the at least one first image and the at least one second image as a component value of corresponding pixels in the stitched third image by using a median fusion scheme.

7. An electronic device comprising:
a binocular camera, which includes a first camera and a second camera;
a shooting unit configured to acquire at least one first image taken by the first camera of the binocular camera and at least one second image taken by the second camera of the binocular camera;
a depth image acquiring unit configured to acquire depth images in scenes of the at least one first image and the at least one second image;
a foreground-background differentiating unit configured to differentiate, based on the depth images, foregrounds and backgrounds in the scenes of the at least one first image and the at least one second image; and
an image synthesis unit configured to match and stitch the foregrounds of the at least one first image and the at least one second image, and match and stitch the backgrounds of the at least one first image and the at least one second image.

8. The electronic device as claimed in claim 7, wherein the foreground-background differentiating unit is further configured to obtain a foreground mask and a background mask in the at least one first image and the at least one second image.

9. The electronic device as claimed in claim 8, further comprising:
a feature point processing unit configured to process the foregrounds and backgrounds of the at least one first image and the at least one second image to obtain a first feature corresponding point transform matrix of the foregrounds of the at least one first image and the at least one second image, and to obtain a second feature corresponding point transform matrix of the backgrounds of the at least one first image and the at least one second image;
a mask optimizing unit configured to optimize the foreground mask and the background mask based on the first feature corresponding point transform matrix and the second feature corresponding point transform matrix;
wherein the image synthesis unit is further configured to match and stitch the foregrounds of the at least one first image and the at least one second image based on the optimized foreground mask, and match and stitch the backgrounds of the at least one first image and the at least one second image based on the optimized background mask.

10. The electronic device as claimed in claim 7, wherein the foreground-background differentiating unit is further configured to differentiate the foregrounds and backgrounds by using a clustering scheme based on depth information in relation to the depth images.

11. The electronic device as claimed in claim 9, wherein the mask optimizing unit is further configured to optimize the foreground mask and the background mask by using a standard graph-cut scheme based on the first feature corresponding point transform matrix and the second feature corresponding point transform matrix.

12. The electronic device as claimed in claim 7, wherein the image synthesis unit is further configured to select a median of component values of pixels in the at least one first image and the at least one second image as a component value of corresponding pixels in the stitched third image by using a median fusion scheme.
